(19) United States
(12) Patent Application Publication
(10) Pub. No.: US 2005/0264535 A1
(43) Pub. Date: Dec. 1, 2005

(54) Touch sensing

(75) Inventors: Mark Thomas Johnson, Eindhoven (NL); Alexander Victor Henzen, Heerlen (NL); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/526,863

(22) PCT Filed: Aug. 4, 2003
(86) PCT No.: PCT/IB03/03404

§ 371 Date: Mar. 4, 2005

(30) Foreign Application Priority Data
Sep. 6, 2002 (EP) 02078673.7

(51) Int. Cl. G09G 5/00

(52) U.S. Cl. 345/173

(57) ABSTRACT

A touch sensitive matrix display senses touch input in sense periods (SP) which are selected to occur non-concurrently with data (DA) written to the pixels (10) of the matrix display during the addressing period (AP). As now, no data (DA) is written to the display while the sensing is performed during the sense periods (SP), the sensing will be less complicated. The sense periods (SP) are selected to occur in-between successive addressing periods (AP) because the display has pixels (10) of which the optical state is maintained substantially longer than the addressing period (AP) lasts. Such a hold period (HP) which lasts substantially longer than the addressing period (AP) is for example available in bistable displays such as electrophoretic displays.

The invention relates to a touch sensitive matrix display, a display apparatus and a method of touch sensing, the matrix display being of a type wherein the pixels have an optical state which, when not addressed, is maintained substantially longer than the period of time required to write the data to the pixels.

In such touch sensitive matrix displays, usually, the data is written into the pixels by selecting a line of pixels associated with a selected one of select electrodes, and writing data to the selected line of pixels. During the addressing period (also referred to as frame period), the lines are selected one by one to supply data to the pixels associated with the selected line. As during the addressing period, continuously data is written to the pixels, the sensing of the touch position in the direction along the lines cannot use the data electrodes. Consequently, a complicated driving scheme is required to sense the touch position, or separate electrodes extending in the direction of the data electrodes have to be implemented.

It is an object of the invention to provide a touch sensitive matrix display with a less complex driving.

A first aspect of the invention provides a touch sensitive matrix display as claimed in claim 1. A second aspect of the invention provides a display apparatus as claimed in claim 9. A third aspect of the invention provides a method of touch sensing as claimed in claim 10. Advantageous embodiments are defined in the dependent claims.

The touch sensitive matrix display in accordance with the invention senses the touch input in sense periods which are selected to occur non-concurrently with the data written to the pixels during the addressing period. As now, no data is written to the display while the sensing is performed during the sense periods, the sensing will be less complicated. The sense periods can be selected to occur in-between successive addressing periods because the display has pixels of which the optical state is maintained substantially longer than the addressing period lasts. Such a hold period which lasts substantially longer than the addressing period is for example available in bistable displays such as electrophoretic displays. Usually, such is display is powered down during the hold period, but now the sensing is performed during the hold period.

The prior art EP-B-0416176 discloses a non-mechanical and a non-emissive matrix display which supplies signals to the row and column electrodes of the display to display information, and which senses with the row and column electrodes the position of a input pen which is electrically coupled to the display. In one embodiment, the touch sense function is performed for a selected row before the display data is supplied. In another embodiment, the touch sense function is performed by scanning all the rows before the display data is supplied to the selected row. Always, the touch sense function occurs at least once in a frame to enable a fast reaction on the movements of the pen, this is essential as the movements of the pen should be displayed on the display to enable to see the characters written by the pen on the display. This way of sensing consumes a relatively high power. The sensing in accordance with the invention is performed at a substantially lower rate than the frame rate and consequently the power consumption is decreased.

In an embodiment as defined in claim 2, during the sense period it is possible to use the existing data electrodes to sense the touch position in the direction of the lines because the data is written during the addressing period only.

In an embodiment as defined in claim 3, the addressing circuit and the sense circuit are operative and consume power only during the addressing period and the sense period, respectively. The power consumed by these circuits outside the respective time periods they are operative will be minimal, and thus the overall power consumption will decrease.

In an embodiment as defined in claim 4, the sensing is repeatedly performed during the hold period during the sense periods which last shorter than the hold period. The sense circuit is powered down outside the sense periods. Consequently, the power consumption will further decrease.

In an embodiment as defined in claim 5, the sense circuit is continuously powered to increase the sensing speed after a first touch input is detected.

These and other aspects of the invention are apparent from and will be elucidated with reference to the embodiments described hereinafter.

In the drawings:

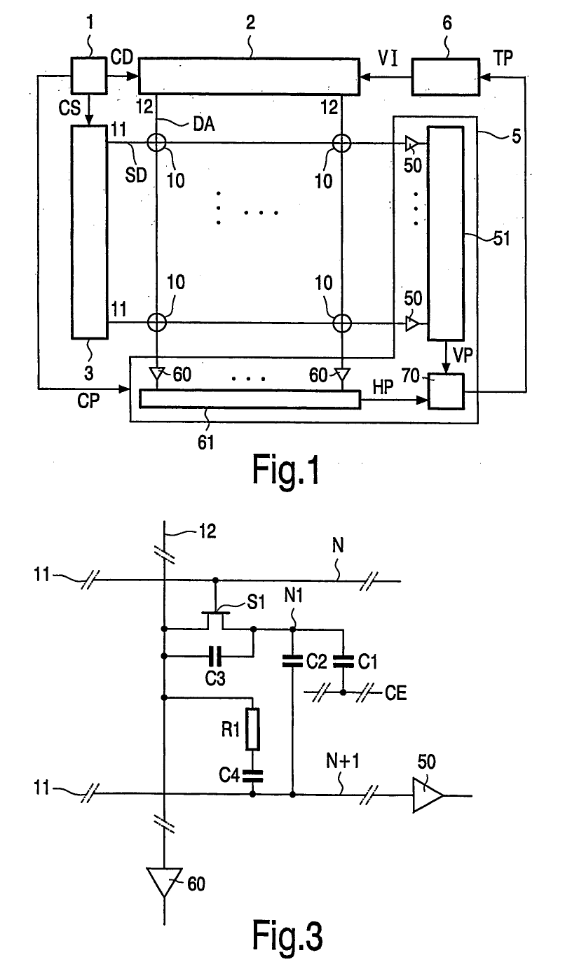

FIG. 1 shows a block diagram of a display apparatus comprising a touch sensitive matrix display,

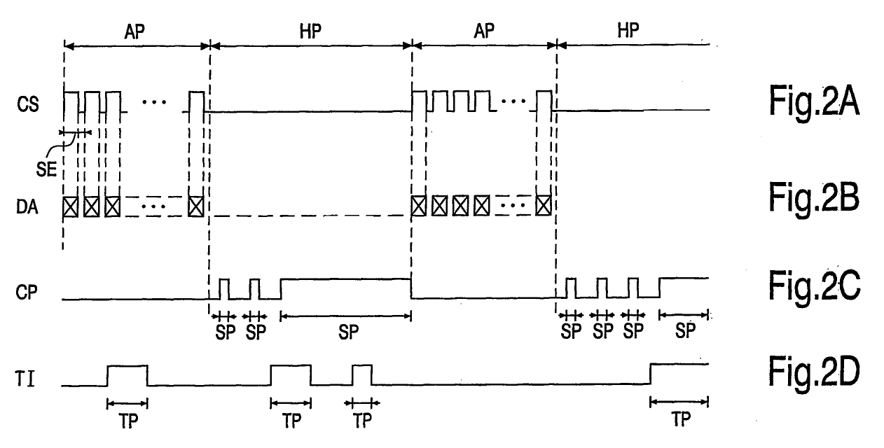

FIG. 2 show signals elucidating the operation of the display apparatus of FIG. 1, and

FIG. 3 shows part of the touch sensitive matrix display in more detail.

The same references in different Figs. refer to the same signals or to the same elements performing the same function.

FIG. 1 shows a block diagram of a display apparatus comprising a touch sensitive matrix display. The touch sensitive matrix display comprises crossing select electrodes 11 and data electrodes 12. The pixels 10 are associated with intersections of the select electrodes 11 and the data electrodes 12. An addressing circuit for driving the display comprises a data driver 2 and a select driver 3. The data driver 2 receives input data VI and supplies data signals DA to the data electrodes 12. The select driver 3 supplies select signals SD to the select electrodes 11.

A sense circuit 5 comprises a plurality of measurement circuits (for example, charge sensitive amplifiers) 50, each one with an input coupled to the select electrodes 11, and a plurality of measurement circuits (for example, charge sensitive amplifiers) 60, each one with an input coupled to the data electrodes 12. A detection circuit 51 coupled to outputs of the measurement circuits 50 supplies a position indication VP, and a detection circuit 61 coupled to outputs of the measurement circuits 60 supplies a position indication HP. A position determining circuit 70 is coupled to the detection circuits 51 and 61 to receive the position VP, HP of a touch event in the direction along the data electrodes 12 and the select electrodes 11, respectively, and supplies the touch position TP.

A control circuit 1 supplies control signals CD, CS and CP to the data driver 2, the select driver 3 and the sense circuit 5, respectively. A signal processing circuit 6 receives the touch position TP and supplies the input data VI to the data driver 2. The input data VI depends on the touch position sensed.

FIG. 2 show signals elucidating the operation of the display apparatus of FIG. 1.

FIG. 2A shows the control signal CS which controls the select driver 3 to select the select electrodes 11 one by one during the addressing period AP. The select time per select electrode 11 is the select period SE.

FIG. 2B shows the data signals DA supplied to the selected one of the select electrodes 11 during each select period SE. During each select period SE, data signals DA have to be supplied to each data electrode 12, as indicated by the crossed blocks.

FIG. 2C shows the control signal CP supplied to the sense circuit 5. A high level of the control signal CP indicates the sense periods SP during which the sense circuit 5 senses for a touch event to determine the touch position. The sense periods SP may occur continuously or intermittently during the hold period HP. The sense period SP may occur continuously from the first touch event detected during one of the intermittently occurring sense periods SP. The sense circuit 5 may be powered during the complete hold period HP or during the sense periods SP only.

FIG. 2D shows touch events occurring during touch periods TP.

The touch events are detected by the sense circuit 5 which comprises the measurement circuits 50 and 60, the touch position determining circuits 51 and 61, and the combiner 70. Touch events which occur during the addressing period AP are not sensed as the sense circuit 5 is inactive during the addressing period AP.

In an embodiment in accordance with the invention, the touch event is determined from a changing property of an element of the pixel 10 or an element provided near to the pixel 10. For example, the changing capacitance of the pixel capacitance of the pixel 10 when a pressure is applied across the pixel 10 may be measured by the measurement circuits 50 and 60 which in this situation are charge sensitive amplifiers. Alternatively, a pressure sensitive element R1 may be arranged near the pixel 10, and the measurement circuits 50 and 60 determine the impedance change of the pressure sensitive element R1, for example, by detecting a current flowing through the pressure sensitive element R1 at a fixed voltage across it. Many alternative ways are possible to detect the touch event. For example, it is also possible to associate a light sensitive element with each one of the pixels 10 to detect a drop in the intensity of light at the touch position(s).

The touch position determining circuit 51 determines the position of the touch event in the direction along the data electrodes 12 from the output signals of the measurement circuits 50 which indicate where in the direction of the data electrodes a touch is detected. Usually, the data electrodes 12 extend in the vertical direction and the touch determining circuit 51 provides the vertical position of a touch event as a number indicating the select electrode(s) 11 corresponding to the vertical position VP the touch event is detected. The touch position determining circuit 61 determines the position of the touch event in the direction along the select electrodes 11. Usually, the select electrodes 11 extend in the horizontal direction and the touch determining circuit 61 provides the horizontal position HP of a touch event. The optional combiner 70 combines the horizontal and the vertical positions into a single data word TP. The circuits 51, 61 and 70 may be dedicated circuits or a microprocessor.

The addressing of the display panel as elucidated with respect to the signals shown in FIG. 2 is an example only. It is also possible to select the pixels 10 in another scheme, for example, one by one.

FIG. 3 shows part of the touch sensitive matrix display in more detail.

The part of the touch sensitive matrix display shown comprises the pixel capacitance C1 of one of the pixels 10, a storage capacitor C2, a column capacitance C3, and a switch S1 which usually is a thin film transistor. The control electrode of the switch S1 is connected to the N^{th} select electrode 11. The main current path of the switch S1 is connected between the data electrode 12 and a node N1. The column capacitance C3 is arranged between the data electrode 12 and the node N1. The storage capacitance C2 is arranged between the node N1 and a successive (N+1)^{th} select electrode 11. The pixel capacitance C1 is arranged between the node N1 and a common electrode CE to which all or a group of the pixels 10 is connected.

A charge sensitive amplifier 50 is connected to the successive (N+1)^{th} select electrode 11 to measure a charge flow via the storage capacitance C2 induced by a changing value of the pixel capacitance C1 due to a touch event. A charge sensitive amplifier 60 is connected to the data electrode 12 to measure a charge flow via the column capacitance C3 induced by a changing value of the pixel capacitance C1 due to a touch event. In prior art matrix displays, it is not possible to connect the charge sensitive amplifier 60 directly to the data electrode 12 because the data electrode 12 is continuously in use to write data to the pixels 10.

Preferably, the column capacitance C3 is sufficiently small compared to the storage capacitor C2 in order to prevent excessive cross talk during display addressing (for example, the value of the column capacitance C3 is at least ten times smaller than the value of the storage capacitor C2).

If the touch position is determined with a separate touch sensitive element R1, the matrix display may be constructed such that this separate touch sensitive element R1 is, for example, arranged in series with a capacitive element C4 between the data electrode 12 and the successive (N+1)^{th} select electrode 11.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A touch sensitive matrix display comprising
a matrix of pixels,
an addressing circuit for writing data (DA) to the pixels during addressing periods (AP), the pixels having an optical state which, when not addressed, is maintained substantially longer than one of the addressing periods (AP),
a sense circuit for sensing during sense periods (SP) a touching position on the display, and
a controller for controlling the addressing circuit and the sense circuit to obtain the addressing periods (AP) and the sense periods (SP) being non-overlapping, wherein the sense periods (SP) do not interrupt the addressing periods (AP), and wherein substantially all pixels are addressed during each one of the addressing periods (AP).

2. A touch sensitive matrix display as claimed in claim 1, characterized in that the touch sensitive matrix display comprises select electrodes and data electrodes, the pixels being associated with intersections of the select electrodes and the data electrodes, and in that the sense circuit comprises a first plurality of measurement circuits coupled to the data electrodes for determining a first coordinate of the touching position, and a second plurality of measurement circuits coupled to the select electrodes for determining a second coordinate of the touching position.

3. A touch sensitive matrix display as claimed in claim 1, characterized in that the controller is adapted for controlling the addressing circuit to be inoperative during a hold period (HP) occurring between subsequent addressing periods (AP) and lasting substantially longer than the addressing period (AP), and for controlling the sense circuit to be operative during at least part of the hold period (HP).

4. A touch sensitive matrix display as claimed in claim 3, characterized in that the controller is adapted for controlling the sense circuit to be operative intermittently during the hold period (HP) to obtain a plurality of separate sense periods (SP) during the hold period (HP).

5. A touch sensitive matrix display as claimed in claim 3, characterized in that the controller is adapted for controlling the sense circuit to be operative continuously during the hold period (HP) after a first touching event has been sensed.

6. A touch sensitive matrix display as claimed in claim 1, characterized in that the touch sensitive matrix comprises light or pressure sensitive elements (R1) in or associated with the pixels.

7. A touch sensitive matrix display as claimed in claim 1, characterized in that the sensing circuit comprises an impedance detector for detecting a change of an impedance of the pixels.

8. A touch sensitive matrix display as claimed in claim 1, characterized in that said matrix display is an electrophoretic display.

9. A display apparatus comprising
the touch sensitive matrix display as claimed in claim 1, and
a signal processor for supplying input data (VI) to the addressing circuit in dependence on the touch position sensed to generate at least part of an image to be displayed on the touch sensitive matrix display.

10. A method of touch sensing with a touch sensitive matrix display comprising a matrix of pixels, the method comprising
writing data (DA) to the pixels during addressing periods (AP), the pixels having an optical state which, when not addressed, is maintained substantially longer than one of the addressing periods (AP),
sensing during sense periods (SP) a touching position on the display, and
controlling the addressing and the sensing to obtain the addressing periods (AP) and the sense periods (SP) being non-overlapping, wherein the sense periods (SP) do not interrupt the addressing periods (AP), and wherein substantially all pixels are addressed during each one of the addressing periods (AP).
